(19) United States
(12) Patent Application Publication
(10) Pub. No.: US 2010/0049804 A1
(43) Pub. Date: Feb. 25, 2010

(54) Instant Messaging

(75) Inventors: Timo P. Tervo, Oulu (FI); Kirmo Koistinen, Oulu (FI); Kari Kaarela, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 12/086,903

(22) PCT Filed: Dec. 22, 2005
(86) PCT No.: PCT/FI2005/050481

§ 371 Date: Jun. 19, 2008

(51) Int. Cl. G06F 15/16

(52) U.S. Cl. 709/206

(57) ABSTRACT

An instant-messaging system (IM) includes messaging devices equipped with individuating addresses, which include a client functionality and a transceiver or data-transmission-reception means for performing instant messaging between the messaging devices, and each of which messaging devices is equipped with messaging capabilities, which messaging capabilities differ at least partly between the messaging devices, and a server functionality arranged to maintain information on the messaging devices belonging to the instant-messaging system. The server functionality is arranged to maintain information on the messaging capabilities of the messaging devices.

### BACKGROUND

The present invention concerns to an instant-messaging system, which includes
messaging devices, equipped with individuating addresses, which include a client functionality and a transceiver or data-reception-transmission means for performing instant messaging between the messaging devices, each of which messaging devices is equipped with messaging capabilities, which messaging capabilities differ at least partly between the messaging devices and
a server functionality arranged to maintain information on the messaging devices belonging to the instant-messaging system.

In addition, the invention also concerns to a corresponding method, messaging device, and program product for implementing the instant messaging according to the invention.

Various instant-messaging applications i.e. ‘chats’ are known from wireless messaging devices. Starting and using instant-messaging, i.e. IM services require users to have received, in their messaging device, the settings demanded by the service. Settings are required for being in contact with the particular IM server arranged in the data-transmission network and, through it, for communicating with other messaging users. These settings are, for example, the access point of the service, i.e. the address of the server (IP address), as well as the user ID and possible password.

However, there are several practical problems associated with the prior art, relating to the implementation of IM services. One such problem is the strong server-centeredness of the implementations. According to the prior art, it is necessary to login to the instant message server. This means that it may not necessarily be possible to guarantee any longer the privacy of the parties. In addition, transmission of messaging from one device to another takes place through the server/as organized by the server. In addition, for the server to be able to serve all those messaging parties, it will require a great processing capability. Such servers and their maintenance are highly cost-intensive. In general, server-centeredness limits the implementability of instant-messaging systems in various situations.

A second practical problem is the diversity of the equipment. This is emphasized particularly in the case of portable devices. This is because many modern devices are namely equipped with various messaging capabilities, of which can even be many in a device. The messaging capabilities of devices can differ from each other, which will cause problems in messaging. A message that is sent in a specific format by one device may namely not necessarily appear correctly, or even at all in another device, if that device does not support the messaging format. It is difficult to determine the capabilities of the devices of other users, which may even change along with a change of device, which may lead to messaging not having the rich content that it has at the best of times.

### SUMMARY

An intention of the present invention is to create a new type of instant-messaging system. Owing to the invention the instant-messaging system can be implemented substantially more easily and simply, compared to known solutions. Owing to the invention the number of those contactable by instant messaging will also be increased. Further, the invention is also intended to create a corresponding method, by means of which an instant-messaging service can be implemented in a simple manner, between practically all parties capable of using instant messaging in a data-transmission network system.

The instant-messaging system according to one embodiment comprises one or more messaging devices equipped with individuating addresses, said messaging device including at least a client functionality and a transceiver or data-reception-transmission means for performing instant messaging between the messaging devices and messaging capabilities, which messaging capabilities differ at least partly between the messaging devices; and a server functionality arranged to maintain information on the messaging capabilities of the messaging devices belonging to the instant-messaging system.

The method according to one embodiment comprises performing instant messaging using one or more messaging devices equipped with individuating addresses and with messaging capabilities, which differ at least partly from each other; and using a server functionality to maintain information on the messaging capabilities of the messaging devices participating in the instant messaging.

The messaging device according to one embodiment comprises a client functionality and data-transmission device or means, and an address, individuating the messaging device in an instant-messaging system, and messaging capabilities, which differ at least partly from the messaging capabilities of other messaging devices belonging to the instant-messaging system, wherein the messaging device is arranged to maintain information on the messaging capabilities of the other messaging devices belonging to the instant-messaging system.

The program product according to one embodiment comprises a computer readable memory medium and program code written on the memory medium configured, when run on a messaging device, to perform instant messaging with other messaging devices belonging to an instant-messaging system, wherein the program code comprises instructions that maintain information on the messaging capabilities of the other messaging devices belonging to the instant-messaging system.

In the invention, information is maintained concerning the messaging capability of each device. Owing to that smooth instant-messaging can be performed, even between devices with messaging capabilities differing greatly from each other. By recognizing the messaging capabilities of the other party and the capabilities of the device itself, messaging can be performed in a manner that includes the richest content possible.

According to one embodiment, information on the messaging capabilities of the devices is maintained using a server functionality. According to one embodiment, the server functionality is, surprisingly, in the messaging devices themselves. This means that the network system requires no special instant-messaging server, through which messaging must be performed.

Owing to the invention, the advertising of capabilities to other devices also takes place efficiently and simply. In addition, user interaction has been minimized, for example, when joining instant messaging. This is important, as the end user cannot be assumed to possess advanced configuration abilities, in order to join instant messaging.

The invention also permits instant messaging even without an actual physical network system. In that case, the messaging devices themselves take care of generating and managing the addresses. The other characteristic features of the invention will become apparent from the accompanying Claims while additional advantages achieved are itemized in the description portion.

### BRIEF DESCRIPTION OF THE DRAWINGS

The invention, which is not restricted to the embodiments disclosed in the following, is examined in greater detail with reference to the accompanying figures, in which

FIG. 1 shows a rough schematic diagram of one example of the system according to the invention,

FIG. 2 shows a rough schematic diagram of one example of the messaging device according to the invention,

FIG. 3 shows an event diagram of one embodiment of the operation of the invention, and

FIG. 4 shows one embodiment of a user database according to the invention, arranged in one messaging device.

### DETAILED DESCRIPTION

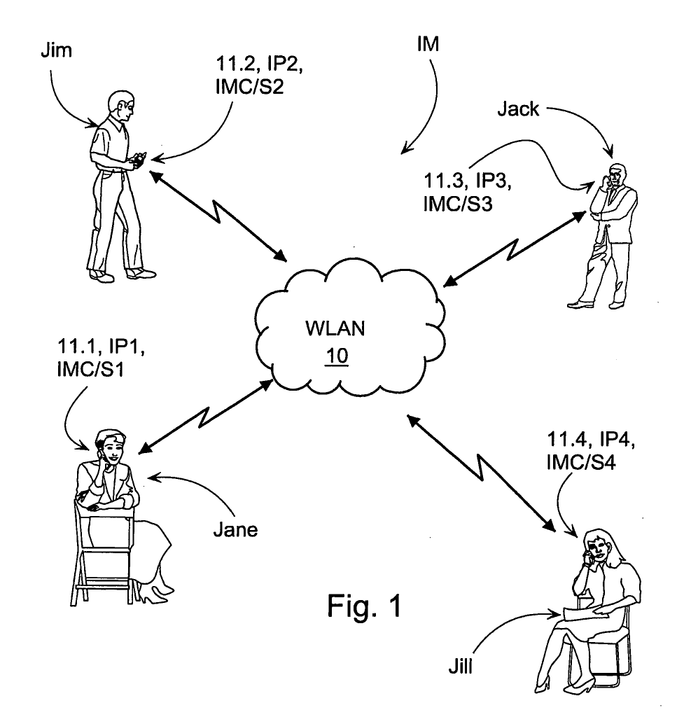

FIG. 1 shows a rough schematic diagram of one example of the system according to the invention, for implementing instant messaging (IM). In this case, the system IM comprises a possible data-transmission network system 10, to which one or several messaging devices 11.1-11.4 can be connected. Owing to the invention an embodiment without an actual network system 10 is also possible.

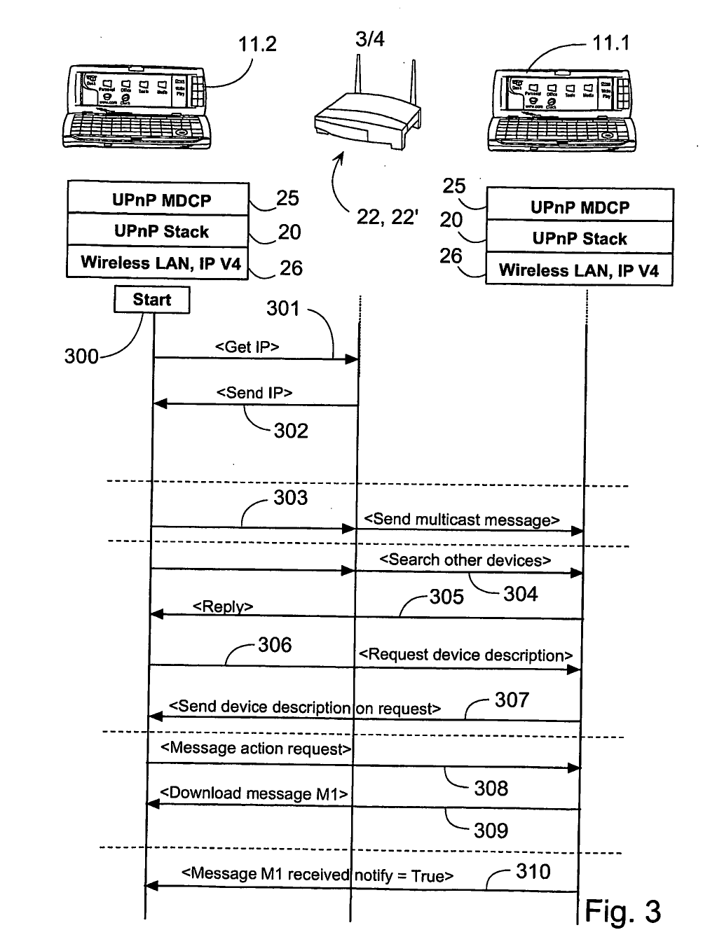

In the invention, the data-transmission network 10, in which the instant messaging is performed, essentially consists of a single block. The network 10 can be of a type that is, as such, already known, or still being developed. One first example of a data-transmission network is a wireless and/or wired local area network. The wireless network can be, for example, of a Bluetooth or WLAN (Wireless Local Area Network) type. The wired network can be, for example, Ethernet or IP network formed by PC computers. The network system 10 can also consist of several network systems, which are connected to each other, but which nevertheless essentially form a single unified and logical segment. In such a system, the possible Multicast relaying of a network element 22 (see FIG. 3) can, for example, transmit the requests and commands of the devices 11.1-11.4 to the other devices 11.1-11.4 in the network 10, but, however, the devices only acknowledge the requests and commands addressed to them and do not react to traffic addressed to the others.

According to one embodiment, the data-transmission network 10 can be a packet-data network, such as, for example IP-based (Internet Protocol), in which case instant the messaging performed in the network 10 takes place in packet form.

The data-transmission network 10 can include network components 22 that are, as such, known, for permitting instant messaging and transmitting between the messaging devices 11.1-11.4 instant messaging in it. More generally, it is possible to refer to the basic infrastructure 22 of the data-transmission network 10. In this connection these components 22 will not be itemized in greater detail, as in terms of the invention they can even be, as such, of types known to one versed in the art, for transmitting/permitting traffic between the devices 11.1-11.4, the arrangement of which can in practice be taken care of in several different ways.

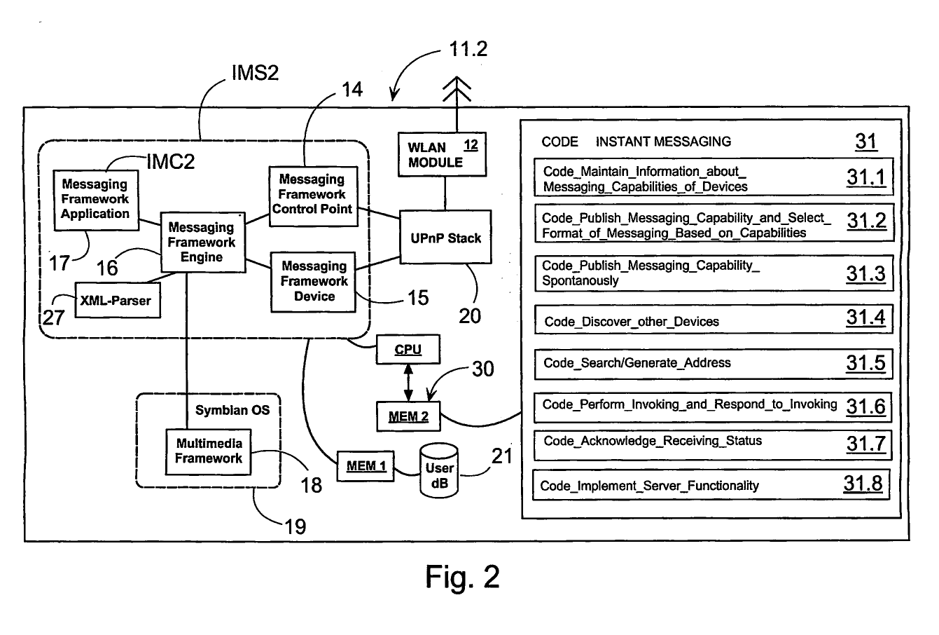

Thus, in the network 10 there can be a numerous group of messaging devices 11.1-11.4 sending instant messages between themselves. FIG. 2 shows a rough schematic diagram of one example of such a messaging device 11.2. The messaging device 11.2 is equipped with a transceiver or other transmission and reception means 12, which are as such known, by means of which instant messaging is performed between the messaging devices 11.1-11.4, and memory devices or memory means MEM1, MEM2. Further, in the device 11.2 there can be a client application IMC1 for performing instant messaging. All or many of the functions of the device 11.2 can be handled by a central processor unit (CPU). One example of the messaging device 11.2 is a mobile station, but a PC computer can also be connected to the system, for example, by a WLAN module.

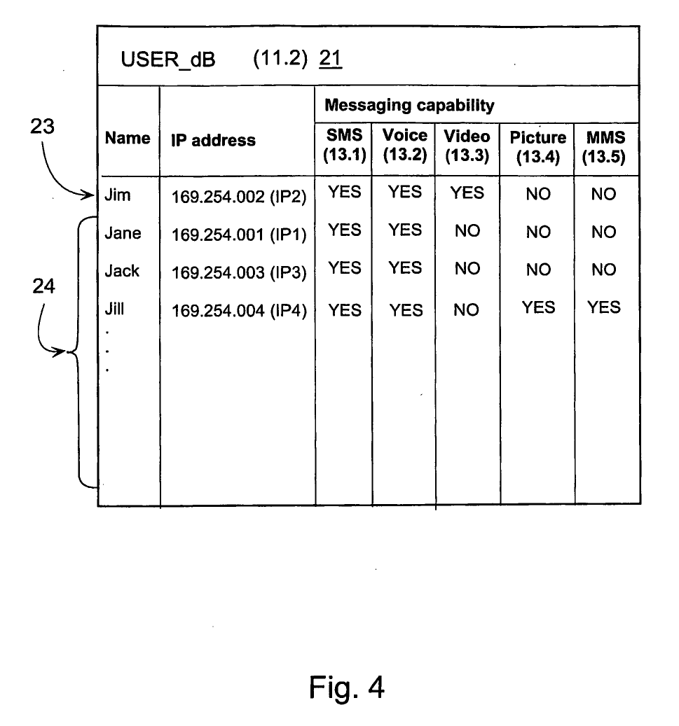

The messaging devices 11.1-11.4 are equipped with messaging capabilities 13.1-13.4 (see FIG. 4). There can be at least one 13.1 of these in each device, but as is known, particularly in portable mobile devices there are more of them. The messaging capabilities 13.1-13.3 are permitted for the device 11.2 by arranging for it the communications protocols and support for the media formats required by the capabilities 13.1-13.3, which are required in order to implement the capabilities 13.1-13.3. Some of the messaging devices 11.1, 11.3 may have more limited capabilities than the other devices 11.2, 11.4. In the case according to the embodiment shown in FIG. 1, the devices 11.1-11.4 of all of the users Jim, Jane, Jack, Jill of the system IM can, for example, handle text messaging (SMS) 13.1 and voice messaging (Voice Messages) 13.2. In addition to these capabilities, the device 11.2 of the user Jim can be equipped with a video-messaging capability 13.3. Similarly, the device 11.4 of the user Jill can have a capability for image messaging (Picture) 13.4. One versed in

the art will understand that in addition to these basic capabilities 13.1-13.4, the devices 11.1-11.4 can have still other messaging capabilities, for example, capabilities for combinations formed from the basic capabilities 13.1-13.4, such as, for example, the device 11.4 of the user Jill can have multimedia messaging (MMS) 13.5.

Each of the devices 11.1-11.4 can be equipped with individuating addresses IP1-IP4 (see FIG. 4). On the basis of these, they can be identified in the single-block network 10 and in the messaging system IM. In this connection, it is not necessary to examine in greater detail the other basic functions of the device 11.2 and functions that are irrelevant in terms of the invention.

In addition to the client functionality IMC2, the device 11.2 may, in this case, also include a server functionality IMS2 (program code or code means 31.8), which in that is performed by the CPU. The server functionality IMS2 arranged in the device 11.2 is used to achieve a surprising zero-configuration feature and also networking ‘invisibility’. Owing to that, it is no longer necessary to maintain in the same sub-network (segment) 10 a separate server, arranged specifically for instant messaging, as is done in implementations according to the prior art. The server functionality IMS2 in the device 11.2 can have several other tasks. In any event, it can also be used to maintain information on other messaging devices 11.1-11.4 connected to the instant-messaging system IM.

More particularly, the server functionality can comprise, as modules, a Messaging Framework Control Point module 14, a Messaging Framework Device module 15, a Messaging Framework Engine module 16, and a Messaging Framework Application module 17. The Messaging Framework Application module 17 controls the Messaging Framework Engine 16 and a Multimedia Framework module 18. The Messaging Framework Engine 16 provides interfaces (API) with applications. The Multimedia Framework module 18 is the server's IMS2 link to the operating-system level. The Messaging Framework Control Point module 14 and the Messaging Framework Device module 15 are connected, for example, to a UPnP protocol stack 20, which is, in turn, linked to the transceiver or data reception-transmission means 12 (which may include a separate transmitter and receiver in different structures). The following is a more detailed description of the tasks of these modules in the device 11.2 and in the method.

FIG. 3 shows the invention as an event diagram, with reference to the system IM shown in FIG. 1 and the device 11.2 shown in FIG. 2. FIG. 3 also shows a WLAN base station 22 belonging to the network 10 and a messaging device 11.1, in relation to which the operation of the device 11.2 is described. It should be understood that besides or instead of the device 11.1, its place can be taken by one or several devices 11.3, 11.4 that are already connected to the network 10. In addition, FIG. 3 also shows one example of a protocol stack with layers 25, 20, 26, by applying which the devices 11.2, 11.1 perform their mutual messaging. In the protocol stack there is a UPnP MDCP (Messaging Device Control Protocol) layer (25), a UPnP stack layer (20), and a Wireless LAN IP V4layer (26). It is assumed that devices 11.1, 11.3, 11.4, which can perform mutual instant messaging in the manner permitted by the system IM, are already connected to the system IM at the moment in question. Now the device 11.2 is connecting to the system, in relation to which the events will be described in the following. In terms of their server functionality, it should be evident that the other devices 11.1, 11.3, 11.4 too possess the same functionalities and can be used to perform corresponding procedures to those of the device 11.2 described in greater detail in the following.

Connection to the system IM can be performed in several different ways. However, the connection to the system IM and its operation are characterized by being dynamical and an address being obtained for the device 11.2 without user interaction.

According to a first embodiment, the basic infrastructure 22 of the data-transmission network 10 can include a functionality 22′, such as a DHCP server (Dynamic Host Configuration Protocol), for automatically generating and distributing identifiers, such as, for example addresses IP1-IP4, individuating the messaging devices 11.1-11.4 in the network 10. In practice, this functionality 22′ can be, for example, in the WLAN base station 22. When advertising its existence/desire to connect to the network 10, and more particularly to perform instant messaging in it, the device 11.2 can express this to the network 10 in a manner that is as such known, as a result of the activation of the device's 11.2 instant-messaging application IMC2, IMS2 (stage 300). In order to take care of this, the device 11.2 can be equipped with, for example, a DHCP client functionality, which then, as stage 301, sends the network 10 a ‘GET IP’ message. As a result, the device 11.2 receives spontaneously from the functionality 221 in the network 10, as stage 302 ‘SEND IP’, an address IP2, which is linked to the device 11.2, and which it should in the future use in the network 10 when messaging with the other devices 11.1, 11.3, 11.4.

According to a second embodiment, when connecting for the first time to the data-transmission network 10, the messaging device 11.2 can also itself search for the functionality 22′ belonging to the basic infrastructure 22 of the data-transmission network 10, in order to obtain the address IP2 to the device 11.2 individuating the messaging device 11.2. If the search does not appear to produce the set result, i.e. the DHCP server is not available or does not even exist at all, i.e. a ‘Send IP’ response is not obtained, the server functionality in the messaging device 11.2 itself can perform for itself a generating process that is, as such, known in order to form an address IP2 individuating itself unambiguously in the instant-messaging system IM. In this case, it is possible to apply, for example, automatic IP addressing (Auto IP, a defined property of the IETF standard). The device 11.2 can generate, for example, with its DHCP client functionality, an address candidate for itself, for example, from the IP address space 169.254.0.0/16. Generally too the address can be generated, for example, from an unrouted, fixed, and well known, for example, from the address space reserved for the local network use (‘reserved link-local block’).

After generating the address, which can be implemented, for example, as random generation, the ARP (Address Resolution Protocol) protocol request concerning the address can be sent to the other devices 11.1, 11.3, 11.4 already belonging to the system for checking. If the address in question is not held by any of the devices 11.1, 11.3, 11.4 already in the system, the device 11.2 can take it for itself. If it transpires that the address in question is already reserved, new generating and checking is performed as often as necessary, until a free address is found. If the system IM is an Auto IP of this kind, the devices 11.1-11.4 can also from time to time check whether the network has possibly acquired a DHCP server functionality 22′. For this operation totality, there can be program code or a code means 31.5 in the device 11.2, by means of which matters relating to addressing can be handled.

Once the device 11.2 has, for example, as a result of stages 301 and 302, obtained its address IP2 for messaging in the instant-messaging system IM, it can next, as stage 303, inform the other devices 11.1, 11.3, 11.4 that are already in the system of its connection to the system IM, and can also search for other devices 11.1, 11.3, 11.4 that are already in the network 10. Of course, the advertising can also be performed after connecting, for example, at regular intervals.

According to one embodiment, the discovery protocol SSDP (Simple Service Discovery Protocol), for example, can be applied when the device 11.2 is advertising its own capabilities and searching for new devices. Notification of the existence of the device 11.2 is shown by the ‘SEND MULTICAST MESSAGE’ message in the event diagram of FIG. 3. The SSDP can use the HTTP over the multicast and unicast UDP. The Control Points 14 of the other devices 11.1, 11.3, 11.4 can register the advertising and particularly the URL address of the device 11.2 that has just connected to the system IM from which they can fetch additional information about the properties/messaging capabilities of the device 11.2 in question or, in general other devices in the system IM.

As a result of publishing its presence, in stage 303 the messaging device 11.2 spontaneously publishes its own messaging capabilities 13.1-13.3 to all of the other messaging devices 11.1, 11.3, 11.4 already connected to the instant messaging system IM and, in addition, also the name/nickname ‘Jim’ of its user, as well as its IP address IP2. At a module level, the publication is handled by the device's 11.2 Messaging Framework Service module 15 (program code or code means 31.2, 31.3). It permits the device 11.2 to publish a device description/resources/services concerning itself, or at least their source (description document URL) to the other devices 11.1, 11.3, 11.4 of the network 10, and even more particularly to their Control Points 14. This can be handled, for example, as an XML document (eXtensible Markup Language).

In addition to the server functionality IMS of the messaging device 11.2 publishing its messaging capabilities concerning itself to the other messaging devices 11.1, 11.3, 11.4, it, and of course in that case the other devices 11.1, 11.3, 11.4 that already belong to the system IM, also maintain information on the messaging capabilities 13.1-13.4 of the other messaging devices 11.1, 11.3, 11.4. For this purpose, the devices 11.1-11.4 are equipped with a Messaging Framework Control Point module 14. As a result of a Multicast message, each device 11.1-11.4 updates its own database 21, in which information is maintained concerning the devices 11.1-11.4 that have connected to, i.e. are present in the system IM, and particularly of the services that they have advertised (i.e. now their messaging capabilities 13.1-13.4). In particular, information is maintained in the database 21 on these devices which have at least partly the same messaging properties/profiles as the device in question itself. This can be handled by program code or code means 31.1.

FIG. 4 shows one schematic example of the content of such a updatable user database 21, which can be managed by the Control Point module 14 of the devices. In this case, the situation is shown from the point of view of the device 11.2, in the memory MEM1 of which the database 21 in question is situated. The first data record 23 in the database 21 can be the device's 11.2 own data and capabilities 13.1-13.3. In the next records 24, there can be data of the other devices 11.1, 11.3, 11.4 connected to the instant messaging system IM, concerning at least their messaging capabilities 13.1-13.5. The fields of the records 23, 24 can be in the sequence: Name, IP address, Messaging Capability. The Messaging Capability can be divided into possible messaging forms, such as, for example, SMS 13.1, VOICE 13.2, VIDEO 13.3, PICTURE 13.4, MMS 13.5. Each value can be ‘Yes’ or ‘No’, depending what the devices 11.1-11.4 have stated in their XML description documents. It should be evident that in practice the database 21 can be replaced with a data structure, which can be considerably more complex/‘cryptic’. In FIG. 4, the database 21 is indeed shown in an extremely simplified form, in order to illustrate properly the basic idea of the invention.

The messaging devices 11.1-11.4 can also spontaneously map other messaging devices 11.1-11.4 that are connected to the instant-messaging system IM, in order to maintain information concerning their messaging capabilities 13.1-13.4. This mapping can be performed routinely by the device 11.2, for example, at regular intervals, or at in connection with connecting to the system IM. For this purpose there can be program code or code means 31.4 in the devices 11.1-11.4. At a module level, this can also be handled by the Messaging Framework Control Point module 14, using the SSDP protocol. In the event diagram of FIG. 3, this stage is 304 (‘SEARCH OTHER DEVICES’) while the response of the other devices (11.1) to this query as stage 305 (‘REPLY’). More specifically, the other devices (11.1) can send a NOTIFY response as a UDP unicast. With it, the URL is also sent to the device/the service's XML format description document.

If a new, as yet unknown device is found, the device 11.2 sending the query can, as stage 306, send by the Messaging Framework Control Point module 14 an HTTP request concerning the device description of the device 11.1 (‘REQUEST DEVICE DESCRIPTION’). Correspondingly, the device 11.1 replying to the request responds, as stage 307, to the request by using the module 14 to return its device description, for example, in XML format, to the device 11.2 that requested it, which correspondingly updates its own device database 21 on the basis of the information it has received. In the discovery stage (303, 304, 305) the discovery message exchanged can contain only a few essential definitions of the device and its services. Some examples of these are device type, identifier, and an indicator (DescriptionURL) to more detailed information (device/service description document). The actual description document (device/service description document), which is received after the discovery stage, describes the device 11.1 and all the devices (for example, camera) integrated in it, the services supported by the device 11.1 (messaging capabilities 13.1-13.2), manufacturer information, device version, the device's 11.1 website, serial number, etc. At the same time, a list is obtained of the functions of the services 13.1-13.2 and their possible variables. The description document is a fuller information package than, for example, the information provided in the discovery stage. Each device updates its database 21 on the basis of the information provided by the description document and parsed from it by the XML parser 27. This stage too can be handled without user interaction, thus making instant messaging easy and user-friendly.

Next, in the event diagram actual instant messaging between the devices 11.1-11.4 is performed. A suitable communications protocol and media format are selected in the user interface UI of the instant-messaging client application, taking into account the messaging capabilities of the receiving party. Stated generally, on the basis of the information concerning the messaging capabilities of the other devices 11.1, 11.3, 11.4 and the device's 11.2 own messaging capabilities, the messaging device 11.2 can select/propose one or more compatible communications protocols and media formats (=way of performing messaging), using which it then performs messaging with one or more other messaging devices 11.1, 11.3, 11.4. In addition to the invention permitting one-to-one messaging, it is also suitable for broadcast type messaging and group messaging (one-to-many). The MDCP can be configured in such a way that, once the user has selected the recipient(s), the device 11.1 automatically presents the possible forms of messaging, which are supported by the device/devices of the desired recipient/recipients. Through this property, the most effective and content-rich messaging possible is permitted, even between devices with messaging capabilities that differ greatly from each other. The device 11.2 can contain program code or code means 31.1, 31.2 for this purpose.

Before stage 308, the message M1 intended for transmission is formed by the user (Jim), using the device 11.2. The user can write the message M1 using the instant-messaging application's MDCP own editor, select an image or video file (image gallery/clip) to be sent as the message, record the message M1 by dictation, or in some other way, depending on the device's 11.2 own capabilities and the known capabilities of the device 11.1 set to be the recipient. In the device 11.2, this is handled by the Messaging Framework Application module 17, which takes into account the capabilities 13.1, 13.2 of the device 11.1 set to be the recipient. Instead of recorded dictation, instant messaging can also take place as a realtime discussion, in which half-duplex or duplex traffic (Poc) can be applied.

Once a message M1 that takes into account the capabilities of the device 11.1 of the recipient Jane has been created, the device 11.2 sends, as stage 308, the network 10 a ‘MESSAGE ACTION REQUEST’ control message. In this case, it is possible to apply, for example, the SOAP (Simple Object Access Protocol) protocol defined in the W3C standard, which also uses XML for expressing the content of the message and the HTTP protocol (over TCP) for transporting the message. The device 11.2 then, in a manner that is as such known, invokes the device 11.1 receiving the instant message M1. The basic infrastructure 22 of the network 10 relays the request to the devices 11.1, 11.3, 11.4 connected to the network 10, of which devices 11.1, 11.3, 11.4 the device 11.1 equipped with the recipient's address IP1 and more specifically its ControlURL picks it up. As stage 309, the device 11.1 defined as the recipient downloads the message M1 from the device 11.2 that has sent it, using the set protocol, for example HTTP. In the same connection, the results or error messages are returned to the Control Point module 14 of the device 11.2 that has initiated the messaging. For the operations in question, there can be program code or code means 31.6 in the devices 11.1-11.4, while it may have been possible to harness the Messaging Framework Control Point module 14 to handle the matter.

Once the message M1 has been downloaded, the device 11.1 that has received the message M1 can send, as stage 310, a state-variable message ‘MESSAGE RECEIVED NOTIFY=True’ expressing in the present value (=True) the success of the reception of the message M1. This can be handled, for example, according to the GENA (General Event Notification Architecture) procedure defined by the IETF. In other words, the Messaging Framework Control Point 14 of the device 11.1 that has received the instant message M1 in the instant messaging acknowledges the state concerning the downloaded instant message M1 to the Messaging Framework Control Point 14 (subscriber) of the device 11.2 sending the instant message M1. There can be program code or code means 31.7 for this purpose in the devices 11.1-11.4.

FIG. 2 also shows the computer readable medium or program product 30 arranged in connection with the server IMS2 formed by the device 11.2. The computer readable medium or program product 30 comprises a memory medium MEM2 and a program code 31, written on the memory medium MEM2, to be executed using the CPU or processor means of the device 11.2.

The program code 31 can comprise several code modules or code means 32.1-32.8 to be executed by the CPU or processor means, the operation of which is described in the event description presented above. The codes can form a group of consecutively performed processor commands, by means of which the functionalities desired in terms of the invention are achieved.

The invention can be applied in numerous different situations, to which the invention is in no way intended to be restricted. Owing to the invention, it is possible to implement new value-added services on top of already existing architectures. One example can be offices equipped with a wireless local area network, in the intranet of which the instant-messaging system operates. For example, the addressing and connection to the system IM, which take place in such embodiments without user interaction, achieve great advantages, because several connections to and disconnections from the system IM can take place daily, in which case no operations are required to be performed by the user in connection with each connection. Because the users can also be grouped, a message can also be sent to all the members of the group. In a dwelling equipped with a wireless local area network, instant messaging can be performed between the rooms in the same way as using a radio telephone. In cafes and in public places various chat services, for example, a dating service, which enrich social life become possible. Because the user cannot always know where services according to the invention are available, spontaneous configuration that takes place without human intervention and, in addition, the determining and maintenance of the messaging capabilities concerning other devices will bring obvious advantages to instant messaging.

One example of a profile, by means of which the invention can be implemented and in the light of which it has been above described, is UPnP (Universal Plug and Play). It permits devices in the same network context to be found and managed effectively and serverless and uses standard Internet protocols, permitting seamless connection to existing networks. Owing to this, the server block IMS2 of the instant-messaging application can reuse the HTTP and XML codes of the UPnP stack, which in turn reduces the size of the application IMS2.

The invention is, of course, not intended to be restricted to only the UPnP profile. Other possible profiles could be, for example, Sun's Jini, the IETF's SLP (Service Location Protocol), and Apple's Rendezvous. The essential feature of the invention is the maintenance of consciousness of the messaging capabilities of the devices 11.1-11.4 and all the protocols/standards/implementations, which this permits, will of course come into question in order to implement the instant-messaging system IM according to the invention.

It must be understood that the above description and the related figures are only intended to illustrate the present invention. The invention is thus in no way restricted to only the embodiments disclosed or stated in the Claims, but many different variations and adaptations of the invention, which are possible within the scope on the inventive idea defined in the accompanying Claims, will be evident to anyone of skill in the art.

1. Instant-messaging system comprising
one or more messaging devices equipped with individuating addresses, said messaging device including at least a client functionality and data-transmission means for performing instant messaging between the messaging devices and, which messaging capabilities differ at least partly between the messaging devices;
a server functionality arranged to maintain information on the messaging capabilities of the messaging devices belonging to the instant-messaging system.

2. System according to claim 1, wherein said server functionality is arranged in the messaging devices.

3. System according to claim 1, wherein each messaging device is configured to publish its messaging capability to the other messaging devices and to maintain information on the messaging capabilities of the other messaging devices, on the basis of which information and its own messaging capability the messaging device is arranged to perform messaging using a suitable protocol and format.

4. System according to claim 3, wherein the messaging devices are configured to publish their messaging capabilities to other messaging devices belonging to the instant-messaging system spontaneously in connection with their connecting to the instant-messaging system.

5. System according to claim 1, wherein the messaging devices are configured to spontaneously map the other messaging devices belonging to the instant-messaging system in order to maintain information concerning their messaging capability.

6. System according to claim 1, comprising a network system equipped with a basic infrastructure in order to transmit instant messaging between the messaging devices, wherein the basic infrastructure includes a functionality for distributing addresses individuating the messaging devices, and from which the messaging device is arranged to receive such when connecting to the network system.

7. System according to claim 6, wherein the network system is a single block.

8. System according to claim 6, wherein, when connecting to the network system, the messaging device is arranged to search the functionality belonging to the basic infrastructure of the network system for distributing addresses individuating the messaging devices and, if the search does not produce the set result, the messaging device is arranged to perform a generating process in order to form for itself an address individuating it unambiguously in the instant-messaging system.

9. System according to claim 1, wherein, in instant messaging between the devices, a transmitting device is arranged to invoke a device receiving the instant message, as a result of which the receiving device is arranged to download, using a set protocol, the instant message from the transmitting device.

10. System according to claim 9, wherein the device receiving the instant message is arranged to acknowledge the state concerning the downloaded instant message to the device transmitting the instant message.

11. Method comprising performing instant messaging using one or more messaging devices equipped with individuating addresses and, with messaging capabilities, which differ at least partly from each other; and using a server functionality to maintain information on the messaging capabilities of the messaging devices participating in the instant messaging.

12. Method according to claim 11, wherein said server functionality is performed in the messaging devices.

13. Method according to claim 11, comprising publishing the messaging capability of each messaging device to the other messaging devices and maintaining information on the messaging capabilities of the other messaging devices, on the basis of which information and the messaging capability, the messaging is performed using a suitable protocol and format.

14. Method according to claim 13, comprising publishing messaging capabilities of the messaging devices to other messaging devices, belonging to the instant-messaging system, spontaneously in connection with their connecting to the instant-messaging system.

15. Method according to claim 11, comprising mapping spontaneously the other messaging devices belonging to the instant-messaging system, in order to maintain information concerning their messaging capabilities.

16. Method according to claim 11, in which instant messaging is performed in a network system, which is equipped with a basic infrastructure in order to transmit instant messaging between the messaging devices, wherein addresses individuating the messaging devices are distributed by a functionality of the basic infrastructure, and wherein such an address is received from said functionality when the messaging device is connected to the network system.

17. Method according to claim 16, wherein the network system is of a single block.

18. Method according to claim 1, wherein the functionality belonging to the basic infrastructure of the network system for distributing addresses individuating the messaging devices is searched by the messaging device when connecting to the network system and, if the search does not produce the set result, a generating process is performed by the messaging device in order to form for itself an address individuating unambiguously it in the instant-messaging system.

19. Method according to claim 11, wherein in instant messaging between the devices
a device receiving the instant message is invoked by a transmitting device; and
the instant message is downloaded by the receiving device from the transmitting device, using a set protocol.

20. Method according to claim 19, wherein in instant messaging, the state concerning the downloaded instant message is acknowledged by the device receiving the instant message to the device transmitting the instant message.

21. Messaging device comprising
a client functionality; and
data-transmission means; and
an address, individuating the messaging device in an instant-messaging system; and
messaging capabilities, which differ at least partly from the messaging capabilities of other messaging devices belonging to the instant-messaging system;
wherein the messaging device is arranged to maintain information on the messaging capabilities of the other messaging devices belonging to the instant-messaging system.

22. Program product, comprising a memory medium and program code written on the memory medium configured, when run on a messaging device, to perform instant messaging with other messaging devices belonging to an instant-messaging system, wherein the program code comprises instructions that maintain information on the messaging capabilities of the other messaging devices belonging to the instant-messaging system.

23. Program product according to claim 22, wherein the program code further comprises instructions that publish the messaging capabilities of the messaging device to the other messaging devices and maintain information on the messaging capabilities of the other messaging devices, on the basis of which information and its own messaging capability the messaging device is arranged to perform messaging, using a suitable protocol and format.

24. Program product according to claim 23, wherein the program code further comprises instructions that publish the messaging capabilities of the messaging device to the other messaging devices, belonging to the instant-messaging system, spontaneously in connection with its connecting to the instant-messaging system.

25. Program product according to claim 22, wherein the program code further comprises instructions that spontaneously map the other messaging devices, belonging to the instant-messaging system, in order to maintain information concerning their messaging capabilities.

26. Program product according to claim 22, wherein the program code further comprises instructions that search, in connection with connecting to the network system, a functionality belonging to a basic infrastructure of the network system, for distributing address individuating the messaging device, and, if the search does not produce the set result, perform a generating process for forming for the messaging device an address individuating it unambiguously in the instant-messaging system.

27. Program product according to claim 22, wherein the program code further comprises instructions that invoke a device receiving the instant message and correspondingly, as a result of the invoking, download the instant message from a transmitting device, using a set protocol.

28. Program product according to claim 27, wherein the program code further comprises instructions that, when an instant message has been received, acknowledge state concerning the downloaded instant message, to the device transmitting the instant message.

29. Program product according to claim 22, wherein the program code further comprises instructions that implement a server functionality in the messaging device, by means of which information on the other messaging devices belonging to the instant-messaging system is arranged to be maintained.
